(19) United States
(12) Patent Application Publication
(10) Pub. No.: US 2026/0292898 A1
(43) Pub. Date: Sep. 24, 2026

(54) ONE-TO-MANY WIRELESS DEVICE PAIRING STRATEGY FOR ENHANCED REDUNDANCY

(71) Applicant: ProdataKey, Inc., Draper, UT (US)

(72) Inventor: Evan Orme, Lindon, UT (US)

(21) Appl. No.: 19/401,005

(22) Filed: Nov. 25, 2025

Related U.S. Application Data
(60) Provisional application No. 63/746,544, filed on Jan. 17, 2025.

(51) Int. Cl. H04W 76/10; H04W 4/80; H04W 12/037; H04W 40/12

(52) U.S. Cl. CPC H04W 76/10; H04W 12/037; H04W 40/12; H04W 4/80

(57) ABSTRACT

A system and method for implementing a one-to-many Bluetooth pairing strategy designed to address the reliability and maintenance challenges of distributed wireless systems, such as wireless locks and hubs, by replacing the traditional direct wireless lock-to-hub pairing with a hubnet-based system coordinated by a centralized site coordinator, wherein the embodiments of the invention eliminate single points of failure and enhance system resilience, enabling seamless failover and redundancy, allowing communication to reroute through alternate hubs in the hubnet without manual reconfiguration thereby significantly improving system reliability, reducing operational costs, and minimizing downtime compared to traditional solutions.

### BACKGROUND

### Field of the Invention

This invention relates generally to battery-powered wireless devices, and specifically to wireless Bluetooth HUBs that operate with wireless locks. Instead of pairing each wireless lock directly to a single hub, wireless locks are paired to a quorum of hubs under the control of a site coordinator, wherein the site coordinator handles security key exchanges, effectively removing direct dependency on individual hubs.

### Description of Related Art

The primary issues with the prior art revolve around the lack of redundancy, rigidity in configuration, high maintenance costs, and vulnerability to hub failures. These drawbacks make traditional hub and wireless lock systems unreliable, difficult to maintain, and expensive to operate, especially in environments where consistent connectivity and security are critical.

Traditional systems pair each wireless lock directly with a single hub, thereby creating a single point of failure. If the hub fails or becomes unavailable, the wireless lock loses its connection to the network. This results in the inability to access or control the lock remotely. There is now an immediate need for manual intervention to restore functionality. Resources may not be immediately available to address the failure.

Those familiar with hubs and wireless locks understand that there are various common causes of hub failure. For example, there may be a loss of configuration. A configuration loss is generally not something that can be predicted.

Another example is a hardware failure. A hub has several components that may fail including a power supply, a wireless communication module, a network connectivity module, a processor and memory.

Another source of failure is vandalism. The vandalism may be random or intentionally malicious.

When a failure of a hub occurs, fixing it typically requires dispatching a technician to the site, which may involve considerable labor and travel time. The process also requires physical access to the hardware, which can further complicate the process if it is not readily accessible.

Another problem of the prior art is a rigid configuration. Pairing between a wireless lock and its designated hub is fixed. When a hub fails, every affected lock must be manually reprogrammed to pair with a new hub. This makes system recovery slow and cumbersome, and emergency troubleshooting becomes more challenging and costly.

Another problem that may arise in the prior art is bugs, outdated firmware, or corrupted software that may lead to operational problems or prevent the hub from connecting properly to wireless locks.

The ultimate drawback of the prior art is a lack of redundancy built into the system. Current systems do not provide a way for communication to seamlessly fail over to an alternate hub. This lack of redundancy means that any hub failure immediately disrupts service, creating downtime and operational issues.

While direct wireless lock-to-hub pairing may be seen as a security feature, it also rigidly ties the wireless lock's configuration to a specific hub. The inability to adapt dynamically without manual intervention limits flexibility without improving security in practice.

Thus, failures can stem from a wide range of issues, including software (configuration, firmware), hardware (components, power supply), network connectivity (wireless or wired), environmental factors (interference, obstruction), and physical damage (vandalism, wear and tear). These vulnerabilities make redundancy and self-healing mechanisms critical for maintaining system reliability.

It would be an advantage over the prior art to find a system and method for pairing wireless locks to a quorum of hubs under the control of a site coordinator, thereby effectively removing direct dependency on individual hubs and providing for self-healing mechanisms to be in place.

### BRIEF SUMMARY

The present invention is a system and method for implementing a one-to-many Bluetooth pairing strategy designed to address the reliability and maintenance challenges of distributed wireless systems, such as wireless endpoints and hubs, by replacing the traditional direct wireless lock-to-hub pairing with a hubnet-based system coordinated by a centralized site coordinator, wherein the embodiments of the invention eliminate single points of failure and enhance system resilience, enabling seamless failover and redundancy, allowing communication to reroute through alternate hubs in the hubnet without manual reconfiguration thereby significantly improving system reliability, reducing operational costs, and minimizing downtime compared to traditional solutions.

### BRIEF DESCRIPTION OF THE SEVERAL VIEWS OF THE DRAWINGS

FIG. 1 is a block diagram of a prior art configuration of a wireless lock and hub system.

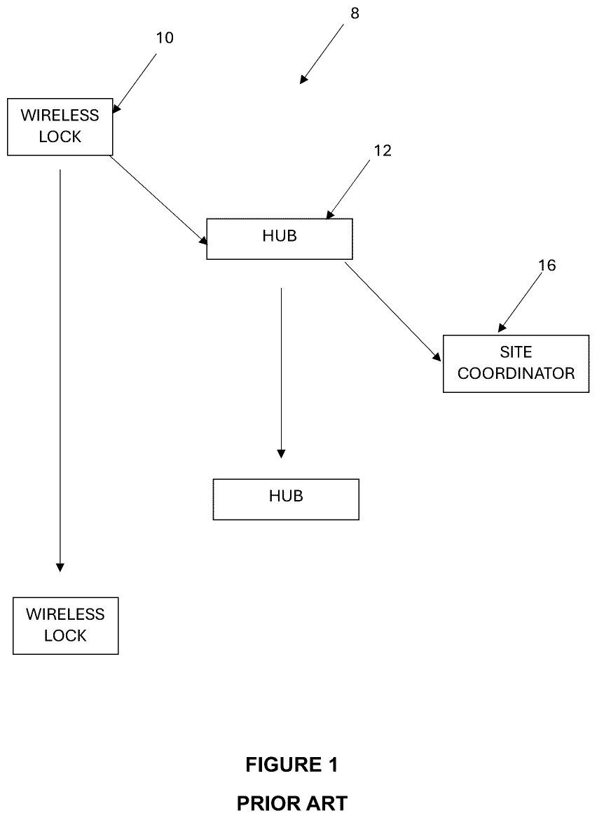

FIG. 2 is a block diagram of the first embodiment of the invention.

FIG. 3 is a block diagram that illustrates the inclusion of an unaffiliated endpoint device.

FIG. 4 is an internal composite link score table is kept by the site coordinator.

FIG. 5 is a block diagram that illustrates the inclusion of an unaffiliated hub.

### DETAILED DESCRIPTION

Reference will now be made to the embodiments of the invention in which the embodiments will be discussed so as to enable one skilled in the art to make and use the embodiments of the disclosure. It is to be understood that the following description illustrates embodiments of the present disclosure and should not be viewed as narrowing the claims which follow.

The description below describes the operation of wireless Bluetooth systems, such as wireless endpoints such as wireless locks, as well as hubs, by introducing a one-to-many pairing strategy. The focus is on improving reliability, redundancy, and maintenance efficiency without compromising security. The following description details how the system operates, the role of each component, and the processes involved.

The embodiments of the present invention are directed to the reliable operation of wireless locks and hubs. However, because the present invention may be applied to the use of any wireless device and hubs, the term “wireless locks” is interpreted as meaning any wireless endpoint device to reflect that broader understanding of the invention. Wireless endpoints may be any endpoint that talks over a low-power RF path to the hubnet and the site coordinator. In broad terms, such devices can be described as wireless endpoint devices, wireless client/client devices, wireless node/field devices, Bluetooth LE peripherals, or battery-powered wireless devices. Such devices may include, but are not limited to sensors (e.g., environmental or occupancy sensors), wall-mounted access panels (e.g., keypads or door-control panels that signal wirelessly), alarm components (wireless alarm or intrusion peripherals), and wall-powered smart light switches that use wireless signaling (power is wired, signaling is RF).

A hubnet is a logical quorum of two or more wireless hubs that collectively provide RF reachability and transport between a population of battery-powered wireless endpoint devices (e.g., locks) and a centralized site coordinator that operates security and makes routing decisions. Unlike prior systems that pair each wireless endpoint to one specific hub, the embodiments herein bind each wireless endpoint to the site coordinator and treat the hubs as interchangeable RF bridges. This separation removes direct dependency on any single hub, simplifies installation, and enables seamless failover when a hub is unavailable (maintenance, power loss, vandalism, RF interference, or device failure).

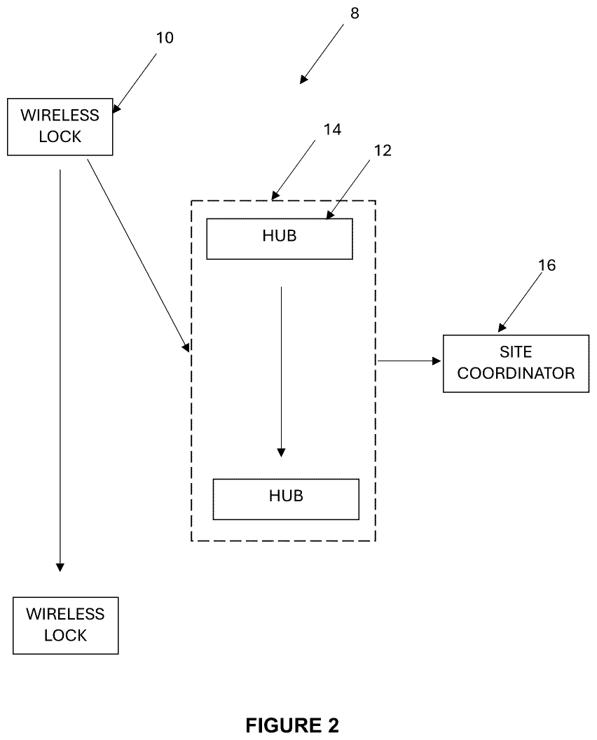

FIG. 2 is a block diagram of the first embodiment of the invention that shows hub-endpoint relationships at a high level. The site coordinator (also called “cloud node” or “gateway” in the embodiments) represents the authoritative control point for identity, keying material, security, association state, policy, and telemetry. The site coordinator may be implemented in many different devices. What is important is that the site coordinator is the edge control-plane anchor—a gateway/orchestrator that authenticates and enrolls devices, manages keys and policy, coordinates associations, aggregates telemetry, and securely bridges the site to upstream services.

More specifically, the site coordinator may function as an authoritative control point, and is the place where devices enroll, authenticate, and are admitted to the network; it issues or brokers trust (keys, certificates), maintains association state, and applies policy. It may also be a policy distribution point and config orchestrator that pushes configuration, access rules, and software/firmware directives to endpoints and subsystems, and manages their lifecycle.

The site coordinator may also function as a telemetry/observability aggregator that collects status, metrics, and logs from devices, normalizes them, and forwards them to analytics or cloud services. The site coordinator may also function as a boundary bridge/gateway that interconnects a local site network (often with constrained or proprietary protocols) to upstream WAN/cloud services, handling protocol translation and secure tunneling.

Each physical site may host an independent site coordinator and corresponding hubnet. In multi-site deployments (e.g., a chain with geographically distributed stores) multiple site coordinators may coexist under a single customer “system,” with a unified people/credential database at the system level and per-site hubnets for RF isolation. For manageability, cloud nodes may be limited to a predetermined maximum per system (e.g., 100), though such limits are implementation choices, not limitations of the inventive concept.

FIG. 2 shows that the first embodiment of a system 8 that includes one or more wireless endpoint devices or locks 10. The second components are a plurality of wireless hubs 12 that form the hubnet 14. A final component is a site coordinator 16 that manages the hubnet 14 and the wireless locks 10.

The wireless locks 10 require communication and remote management capabilities. Each of the wireless locks 10 pairs with the site coordinator 16, rather than directly with an individual hub 12 of the hubnet 14.

The hubs 12 serve as intermediaries between the wireless locks 10 and the site coordinator 14. The hubs 12 may act as transparent conduits for transmitting data, without managing security keys or performing encryption. In the first embodiment of the invention, the hubs 12 are organized into a quorum, meaning a group of hubs that can interchangeably handle communication with the wireless locks 10.

It should be understood that the hub described above may be implemented using many different devices that may be functionally equivalent to the hub. For example, functional equivalents to network hubs may be network switches and wireless access points, which have largely replaced hubs in modern networking due to their superior efficiency and performance. Switches are the direct upgrade, connecting devices on a local area network (LAN) like a hub, but directing traffic only to the intended recipient instead of broadcasting it to everyone. Wireless access points serve a similar function, creating a network and allowing devices to connect to it wirelessly. Therefore, the term “hub” may be expanded to include any device that performs the functionality of a hub and is be limited strictly to the strict definition of a hub.

In the first embodiment, the site coordinator 16 now serves as the central component responsible for managing security and coordination. This is accomplished by managing key exchange, encryption, and authentication for all wireless locks 10 in the system. The site coordinator 16 also ensures redundancy by dynamically routing communications through available hubs 12.

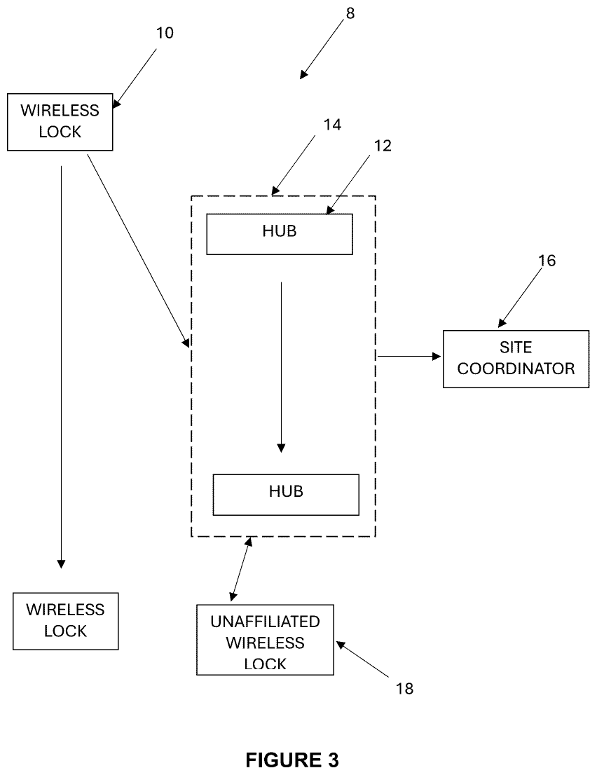

As shown in FIG. 3, each hub 12 in the hubnet 14 performs periodic or continuous RF scanning (e.g., Bluetooth LE observer role) to discover new nearby devices. Raw sighting events may include a device identifier (e.g., MAC address or pseudonymous rotating identifier), received signal strength indication (RSSI), timestamp, optional channel/PHY data, and hub identity. The hubs 12 transmit sightings to the site coordinator 16, which may aggregate observations across the hubnet 14 and composes an RF-topology view of which wireless locks 10 are observable from which hubs, and at what relative signal strengths. The first embodiment may include a user interface (UI) “Discovery” view where hubs 12 routinely listen and report all the Bluetooth devices that are seen, and with relative signal strengths, enabling the site coordinator 16 to recognize unaffiliated wireless locks 18.

When the site coordinator 16 identifies an unaffiliated wireless lock 18 (e.g., a new wireless lock broadcasting in range) it may present the device for operator approval. Enrollment binds the unaffiliated wireless lock 18 to the site coordinator 16, and not to any specific hub 12. When adding a wireless lock 10, the connection field is a group (e.g., Hubnet 14), with no user configuration to say it connects to any specific hub 12. After enrollment, the wireless lock 10 is free to use any hub 12 in the hubnet 14 as its RF bridge.

During enrollment of an unaffiliated wireless lock 18, the site coordinator 16 generates, provisions, or negotiates cryptographic keys with the unaffiliated wireless lock. Hubs 12 do not store long-term device keys, minimizing sensitive material at the edge. Payloads between wireless locks 10 and the site coordinator 16 remain encrypted end-to-end through the hub, rendering hubs effectively opaque relays.

During set up or initialization operations, all wireless locks 10 are essentially unaffiliated and are paired with the site coordinator 16, which becomes their primary communication partner. The site coordinator 16 generates and exchanges security keys with each wireless lock 10. These security keys are used to encrypt and authenticate all subsequent communication.

Each hub 12 is associated with the site coordinator 16 and added to the hubnet 14. This process involves ensuring the hub 12 can communicate with the site coordinator 16 and configuring the hub to function as a transparent relay, capable of forwarding data to and from the wireless locks 10. The site coordinator 16 may be responsible for tracking which hubs 12 are active and available within the system.

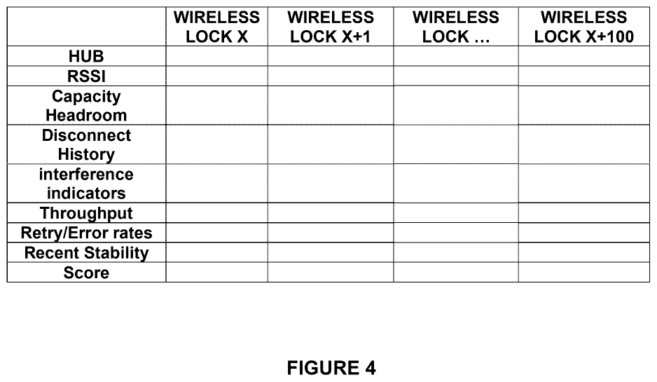

FIG. 4 shows that an internal composite link score table is kept by the site coordinator 16. For each pair of wireless lock 10 that passes through a specific hub 12, the site coordinator 16 maintains a composite link score representing routing desirability. In this embodiment, the hubs 12 themselves don't have scores. Rather, each wireless lock-hub combination has a composite link score. As FIG. 4 shows, RSSI contributes prominently, but capacity headroom, disconnection history, interference indicators, throughput, retry/error rates, and recent stability may factor into the score. The route chosen is the highest-scoring available hub 12 for that wireless lock 10 at decision time.

It should be understood that the factors that are scored as shown in FIG. 4 may be increased, decreased, or modified as desired.

To avoid overloading a single “best-RSSI” hub 12, the score may introduce a penalty as the hub's utilization approaches a threshold (soft limit), encouraging marginal wireless locks 10 to select alternate hubs with more headroom. Therefore, any wireless lock 10 may be using a less-than-optimal hub 12 because the optimal hub is at capacity.

To prevent oscillation (flapping) between hubs 12 with near-equal scores, the site coordinator 16 enforces hysteresis. In this way, a candidate hub 12 must exceed the incumbent score by some margin for a dwell time T before migration of the wireless lock 10 to a new hub. Optionally, cool-down timers may prevent immediate reversions to a previous hub 12. Thus, the site coordinator 16 may use “anti-flapping” logic to prevent unnecessary movement between hubs 12.

If the current or “serving” hub 12 fails or becomes unreachable, the site coordinator 16 may promote the next highest-scoring hub for the wireless lock 10, reestablishing the data path without re-pairing. Because security keys terminate at the site coordinator 16, reroute does not require cryptographic reconfiguration at the hub 12. This quick change of a hub 12 upon hub failure may result in sub-second command latency even as the path traverses hubnet 14 infrastructure and thereby providing low-latency resumption after failover. In other words, the system 8 provides dynamic rerouting and no down-time upon hub failure.

Operation of the system 8 proceeds with each wireless lock 10 communicating with the site coordinator 16 through the highest scoring (or nearest alternate) hub 12. The hub 12 acts as a passive relay, forwarding encrypted packets between the wireless locks 10 and the site coordinator 16 without interpreting or altering the data.

The hubnet 14 ensures that no single hub becomes a critical point of failure. Even if multiple hubs 12 fail simultaneously, as long as one hub remains functional, the wireless lock 10 maintains its connection to the site coordinator 16.

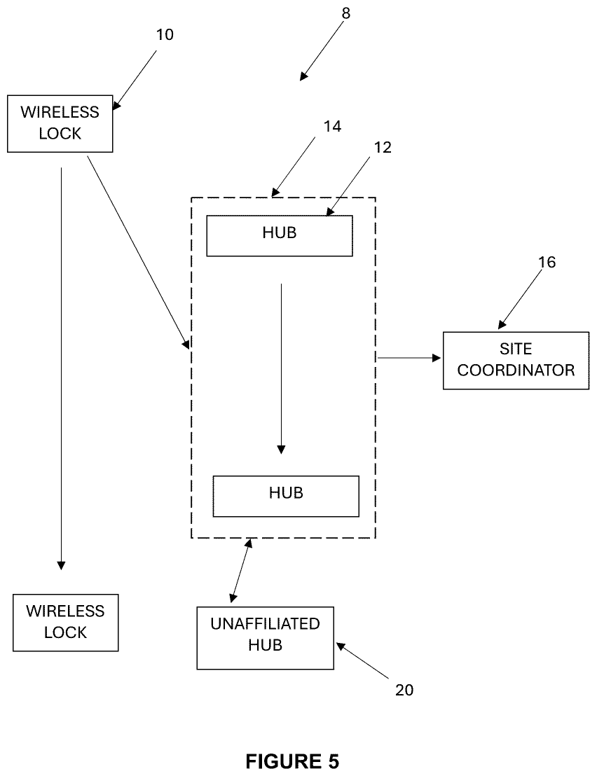

FIG. 5 shows that when a new hub is installed, it is associated with the site coordinator 16 and automatically joins the hubnet 14. The unaffiliated hub 20 is recognized and the new hub is added in substantially the same manner as an unaffiliated wireless endpoint device 18 as shown in FIG. 3. Once recognized by the system 8, it is recognized as an unaffiliated device and is added to the site coordinator 16.

Wireless locks 10 immediately recognize the new hub 12 as part of the system and can begin using it without requiring any changes to their configuration. The new hub 12 will be added to the internal composite link score table shown in FIG. 4, and the site coordinator 16 may make changes to the routing of one or more wireless locks 10.

Operator UI may expose (i) a device's current hub association, (ii) hub inventory/health, (iii) discovery lists of unaffiliated devices, and (iv) coarse signal indicators. However, the composite link score tables are not exposed to customers. These tables exist as internal telemetry. This separation allows the system to remain self-healing without burdening operators with volatile RF details.

One of the main advantages of the first embodiment is reduced technician intervention. Traditional systems require technicians to reconfigure wireless locks 10 manually when a hub 12 fails. This first embodiment eliminates that need by abstracting the lock-hub pairing through the site coordinator 14. Technicians may now install new hubs 12 or replace faulty ones without modifying the wireless locks 10 themselves.

The site coordinator 16 may maintain per-device association journals: time-stamped hub choices, score snapshots at decision points, penalties applied (e.g., “disconnect penalty”), and resulting migrations. A “why-moved” view reconstructs the exact score deltas and hysteresis that triggered migration that is useful for remote diagnostics and capacity planning.

Battery-powered wireless locks 10 usually adopt low-duty listening or standards-based wake techniques so that a site coordinator 16 may reach down and request an action with minimal power drain. Polling is kept to a minimum, and Bluetooth techniques are leveraged to wake devices with relatively little latency, enabling UI-initiated actions to be complete rapidly.

Two latency paths are relevant. The first is credential-at-the-door events (local to the wireless locks 10 with minimal RF round-trip) and the second is cloud-initiated commands (site coordinator→hub→wireless locks), which depend on the wireless locks'listen schedule. The system may advertise percentile latency bands for typical schedules, while allowing deeper sleep policies during predicted idle windows.

All application payloads are encrypted and authenticated between wireless locks 10 and the site coordinator 16. Hubs 12 forward ciphertext and do not store long-term device keys. Compromise or replacement of hubs 12 therefore does not jeopardize wireless lock 10 keys or require technicians to re-pair devices.

The site coordinator 16 may rotate session keys on a schedule or reactively (e.g., repeated disconnects suggesting localized interference), propagate revocation lists, and quarantine misbehaving wireless locks 10. Because hubs 12 are stateless with respect to long-term keys, key lifecycle operations remain centralized and auditable.

In some embodiments, the site coordinator computes per-wireless lock 10 wake/sleep timetables informed by (a) local device history (open/close events, command timing), (b) patterns from similar devices/sites, (c) site configuration (e.g., staffing and access rules), and (d) calendar context (workdays, holidays). Timetables deepen sleep during predicted idle windows to save battery while increasing listen frequency near predicted activity peaks. Anomalies, or unexpected events outside predictions, are logged and used to adjust future schedules.

In deployments of systems 8 where two hubnets 14 (each bound to a different site coordinator 16) become RF-proximate—adjacent buildings, the system prevents cross-association. Enrollment and routing are assigned to the designated site coordinator 16/hubnet 14. In the unlikely event that two cloud nodes are within close geographical proximity, a partition is put in place so that cross-communication cannot occur.

Hubs 12 may fail for numerous reasons such as configuration loss, firmware bugs, corrupted state, power supply failure, network interface failure, RF module failure, vandalism, or environmental interference. Prior art systems require dispatching a technician and re-pairing affected endpoints. In contrast, the disclosed embodiments failover to another hub 12 in the hubnet 14 and continue operating while a technician repairs or replaces the failed hub, with no endpoint reconfiguration.

When a new hub 12 is installed or a failed hub is replaced, it authenticates to the site coordinator 12 and joins the hubnet 14. Wireless locks 10 naturally migrate to the new path when the score for the new hub 12 merits it. No fieldwork is required at the wireless locks 10.

While many embodiments leverage Bluetooth LE roles (wireless locks 10 as peripherals; hubs 12 as observers), the embodiments generalize to other low-power RF (e.g., Zigbee, Thread, sub-GHz systems) that support scanning and multi-point observation. Hubs 12 may be multi-radio and multi-channel to increase concurrency. Score components map analogously, including link quality metrics, retries, interference, and load capacity. The invention is not confined to any one PHY or spectrum allocation.

As stated previously, although wireless locks 10 are the principal example, the hubnet pattern applies to sensors, wall-mounted access panels, and alarm components—indeed, such as any device where the signaling path is wireless even if power is wired (e.g., wall-powered smart light switches using wireless signaling). Devices wired only for power but wireless for signaling still benefit.

When hub 12 utilization nears a setpoint, new sessions for lower-priority endpoints bias toward alternate hubs with higher headroom. Existing sessions remain until a meaningful score change justifies migration, keeping churn low.

Sites may mark certain wireless locks 10 as priority (e.g., main entrances). Priority introduces a small positive bias in the score to keep critical endpoints on the most reliable paths during partial outages.

If multiple hubs 12 fail, the system 8 can relax listening schedules (where permissible) or accept slightly higher command latency to keep essential connectivity through the remaining capacity.

The system 8 is essentially self-configuring by recognizing new components added to the system, and failing devices automatically being recognized as no longer reachable by the hubnet 14. As device populations grow, additional hubs 12 may be added. The topology adapts as the score model incorporates new devices.

Firmware updates to hubs 12 become routine because hubs lack long-term device keys. Temporary service interruptions on one hub 12 may be absorbed by the hubnet 14. Site coordinators 16 may provide dashboards (counts of endpoints per hub, capacity headroom, error rate trends) and per-device histories (association journals).

Consider a cloud-initiated command for controlling the system 8. The site coordinator 16 selects the serving hub according to the link score. The hub 12 signals the wireless lock 10 via the configured low-power wake/notify mechanism supported by the RF stack. Upon wireless lock 10 responsiveness, the site coordinator 16 may exchange the encrypted command payload and receives an authenticated result (success/failure, timestamps). Low latency may be consistent with short listen intervals and efficient wake strategies.

The proposed embodiments provide (a) redundancy—no single hub failure strands wireless locks 10, (b) zero-touch hub 12 replacement/addition, (c) improved battery life via site coordinator-assisted listen schedules, (d) simplified scaling and maintenance, and (e) centralized, auditable security posture.

The system may scale easily by adding more hubs 12 to the hubnet 14 or pairing additional wireless locks 10 with the site coordinator 16. The wireless locks 10 and hubs 12 do not require direct knowledge of each other, making expansion straightforward.

In addition, troubleshooting is improved because diagnostic tools at the site coordinator 16 level provide insights into hub 12 status and connectivity, helping identify issues remotely.

In large facilities with multiple wireless locks 10 and hubs 12, this strategy ensures high reliability and minimal downtime, even in the event of hub failures.

In high traffic areas or other locations prone to interference or vandalism, the system 8 benefits from the redundancy and self-healing capabilities. Likewise, in sites where technician access is challenging, the ability to reroute communication and add hubs without manual reconfiguration is invaluable.

The first embodiment moves away from the traditional system that has the disadvantages of low reliability because of single point failure, increased maintenance costs because of the need for manual reconfiguration, limited scalability without manual changes, security key management being tied to individual hubs and therefore high installation complexity. The advantages of the present invention include but should not be considered as limited to redundant communication pathways, automatic failover and minimal downtime, the ability to easily add hubs and wireless locks, a centralized and secure key management system, and simplified installation with dynamic hub association.

The features described herein (e.g., scoring components, thresholds, hysteresis timings, discovery screens, health telemetry, etc.) illustrate workable embodiments and are not intended to narrow the scope of the claims, equivalent structures, parameters, and flows may be substituted without departing from the spirit of the invention.

In summary, the first embodiment is a system for providing wireless connectivity to a plurality of endpoint devices at a site, the system comprising a site coordinator implemented by one or more processors to manage device identity, security context, and routing decisions, a hubnet including two or more wireless hubs each configured to scan for radio-frequency (RF) advertisements, establish transport sessions with the endpoint devices, and relay application payloads, and a control interface by which the site coordinator: (i) receives, from the hubnet, sighting reports that identify unaffiliated endpoint devices observable by the hubs and associated signal measures, (ii) enrolls a selected endpoint device by establishing an end-to-end cryptographic association between the site coordinator and the selected endpoint device while authorizing the hubnet as a relay group without binding the selected endpoint device to any particular hub, and (iii) maintains, for each pair of the selected endpoint device and a candidate hub of the hubnet, a composite link score and selects a serving hub for the selected endpoint device based on the composite link scores.

Likewise, a summary of the method of the first embodiment is a computer-implemented method of operating a multi-hub wireless access network at a site, the method comprising receiving, at a site coordinator, sighting reports from a hubnet of two or more wireless hubs, each sighting report describing an RF observation of an endpoint device, identifying an unaffiliated endpoint device based on the sighting reports, enrolling the unaffiliated endpoint device by establishing an end-to-end cryptographic association between the site coordinator and the endpoint device while authorizing the hubnet as a relay group without binding the endpoint device to any particular hub, calculating, for each pair of the endpoint device and a candidate hub, a composite link score, selecting a serving hub for the endpoint device based on the composite link scores, and enforcing a hysteresis policy that delays migration from the serving hub to a candidate hub until a promotion margin and a dwell interval are satisfied.

Although the preceding description has been described herein with reference to particular means, materials, and embodiments, it is not intended to be limited to the particulars disclosed herein; rather, it extends to all functionally equivalent structures, methods, and uses, such as are within the scope of the disclosure. Accordingly, all such modifications are intended to be included within the scope of this disclosure. It is the express intention of the applicant not to invoke 35 U.S.C. § 112, paragraph 6 for any limitations of any of the claims herein, except for those in which the claim expressly uses the words ‘means for’ together with an associated function.

What is claimed is:

1. A system for providing wireless connectivity to a plurality of endpoint devices at a site, the system comprising:
a site coordinator implemented by one or more processors to manage device identity, security context, and routing decisions;
a hubnet including two or more wireless hubs each configured to scan for radio-frequency (RF) advertisements, establish transport sessions with the endpoint devices, and relay application payloads; and
a control interface by which the site coordinator: (i) receives, from the hubnet, sighting reports that identify unaffiliated endpoint devices observable by the hubs and associated signal measures, (ii) enrolls a selected endpoint device by establishing an end-to-end cryptographic association between the site coordinator and the selected endpoint device while authorizing the hubnet as a relay group without binding the selected endpoint device to any particular hub, and (iii) maintains, for each pair of the selected endpoint device and a candidate hub of the hubnet, a composite link score and selects a serving hub for the selected endpoint device based on the composite link scores.

2. The system of claim 1 wherein the composite link score for a given endpoint device or hub pair comprises at least one metric selected from: a received signal strength indication (RSSI), a utilization measure of the candidate hub, a disconnect or error rate, a retry rate, a throughput estimate, and a recency measure.

3. The system of claim 1 wherein the site coordinator applies a hysteresis policy that promotes migration from a current serving hub to a candidate hub only when the candidate hub's composite link score exceeds that of the current serving hub by a promotion margin for at least a dwell interval and further applies a cool-down interval that inhibits immediate reversion.

4. The system of claim 1 wherein the site coordinator biases the composite link scores according to hub utilization by applying a soft penalty that increases as a utilization setpoint is approached to avoid overloading a single hub.

5. The system of claim 1 wherein the site coordinator records an association journal for each endpoint device, the association journal including time-stamped score snapshots, penalty applications, migration events, and hysteresis decisions.

6. The system of claim 1 wherein the site coordinator detects a failure or unavailability of a serving hub and, without re-pairing the endpoint device, promotes a next highest-scoring hub as the serving hub to maintain service continuity.

7. The system of claim 1 wherein the hubnet relays application payloads as ciphertext that is end-to-end encrypted between the endpoint device and the site coordinator, and the hubs omit storage of long-term cryptographic keys of the endpoint device.

8. The system of claim 1 wherein the site coordinator generates a per-endpoint listen timetable using historical usage, patterns, site configuration, or calendar context, and updates the timetable based on measured command latency or battery metrics.

9. The system of claim 1 wherein the site coordinator assigns a routing priority to at least one endpoint device and adjusts composite link scores to favor a more reliable hub path during degraded operation.

10. The system of claim 1 wherein a customer system comprises a plurality of site coordinators each governing a corresponding hubnet, and wherein the site coordinators enforce a policy partition that prevents enrollment or routing across hubnets absent explicit authorization.

11. A computer-implemented method of operating a multi-hub wireless access network at a site, the method comprising:
receiving, at a site coordinator, sighting reports from a hubnet of two or more wireless hubs, each sighting report describing an RF observation of an endpoint device;
identifying an unaffiliated endpoint device based on the sighting reports;
enrolling the unaffiliated endpoint device by establishing an end-to-end cryptographic association between the site coordinator and the endpoint device while authorizing the hubnet as a relay group without binding the endpoint device to any particular hub;
calculating, for each pair of the endpoint device and a candidate hub, a composite link score;
selecting a serving hub for the endpoint device based on the composite link scores; and
enforcing a hysteresis policy that delays migration from the serving hub to a candidate hub until a promotion margin and a dwell interval are satisfied.

12. The method of claim 11, wherein computing the composite link score comprises combining at least two of: RSSI, hub utilization, disconnect or error rate, retry rate, throughput estimate, and observation recency.

13. The method of claim 11, further comprising:
applying a utilization-dependent penalty to the composite link score to discourage new associations to a hub that approaches a threshold utilization.

14. The method of claim 11, wherein the hysteresis policy further comprises applying a demotion margin and a cool-down interval to reduce oscillations in hub selection.

15. The method of claim 11 further comprising:
detecting a serving-hub failure or degradation;
recomputing the composite link scores; and
promoting a replacement hub as the serving hub without renegotiating long-term cryptographic keys at any hub.

16. The method of claim 11 further comprising maintaining, at the site coordinator, an association journal recording score deltas, penalty applications, and migration events for the endpoint device.

17. The method of claim 11 further comprising:
generating, at the site coordinator, a per-endpoint listen timetable based on historical usage, cohort patterns, site configuration, or calendar context;
transmitting the listen timetable to the endpoint device;
receiving latency and battery feedback from the endpoint device; and
updating the listen timetable in view of the feedback.

18. The method of claim 11 wherein application payloads exchanged between the endpoint device and the site coordinator are end-to-end encrypted and wherein the hubs operate as relays without storing long-term endpoint keys.

19. The method of claim 11 further comprising:
assigning a routing priority to the endpoint device and adjusting composite link scores to preserve connectivity for the endpoint device during degraded network capacity.

20. The method of claim 11 further comprising:
operating a plurality of hubnets respectively governed by distinct site coordinators in a customer system;
detecting RF proximity between hubnets; and
enforcing a policy partition that blocks enrollment or routing across hubnets absent an explicit authorization.
